(19) United States
(12) Patent Application Publication
(10) Pub. No.: US 2024/0034954 A1
(43) Pub. Date: Feb. 1, 2024

(54) REMOVAL OF UNWANTED MINERAL OIL HYDROCARBONS

(71) Applicant: CARGILL, INCORPORATED, Wayzata, MN (US)

(72) Inventor: Gijsbertus Johannes Van Rossum, Spijkenisse (NL)

(73) Assignee: CARGILL, INCORPORATED, Wayzata, MN (US)

(21) Appl. No.: 18/007,315

(22) PCT Filed: Jul. 28, 2021
(86) PCT No.: PCT/US2021/043511

§ 371 Date: Jan. 30, 2023

(30) Foreign Application Priority Data
Aug. 11, 2020 (EP) 20190408.3

(51) Int. Cl. C11B 3/14; C11B 3/10; A23L 5/20

(52) U.S. Cl. CPC C11B 3/14; C11B 3/10; A23L 5/20

(57) ABSTRACT

Present invention relates to a process for reducing the MOSH and/or MOAH content from vegetable oil selected from the group consisting of palm-based oil, cocoa butter-based oil and any mixtures thereof, and comprising steps of: a) subjecting the vegetable oil to a short-path evaporation, wherein the short-path evaporation is performed at a pressure of below 1 mbar, at an evaporation temperature in a range of from 235 and 290° C., and with a feed rate per unit area of evaporator surface of the shorth-path evaporation equipment in a range of from 35 to 102 kg/h·m², and thus obtaining a retentate vegetable oil and a distillate, b) Contacting the retentate vegetable oil with an adsorbent, and c) Subjecting the bleached retentate vegetable oil to a further refining step.

### CROSS-REFERENCE TO RELATED APPLICATIONS

This application claims the benefit of European Provisional Application No. 20190408.3, filed Aug. 11, 2020, which is incorporated by reference herein in its entirety.

### FIELD OF THE INVENTION

The present invention relates to a novel process for reducing the content of MOSH and/or MOAH in vegetable oils selected from the group consisting of palm-based oil, cocoa butter-based oil and any mixture thereof.

### BACKGROUND OF THE INVENTION

Mineral Oil Hydrocarbons (MOH) may be present as contaminants in oils and fat as well in foods prepared thereof. MOH are a complex mixture of molecules that are usually categorized into two main groups: Mineral Oil Saturated Hydrocarbons (MOSH) and Mineral Oil Aromatic Hydrocarbons (MOAH). MOSH are linear and branched alkanes and/or cyclo-alkanes. MOAH consists of highly alkylated mono- and/or polycyclic aromatic hydrocarbons.

Contamination of food and feed products with MOH may occur through migration from materials in contact with food such as plastic materials, like polypropylene or polyethylene, recycled cardboard and jute bags. Contamination also occurs from the use of mineral oil-based food additives or processing aids and from unintentional contamination like for example from lubricants or exhaust gases from combustion engines.

From a health perspective, it is desirable to reduce, or even completely remove, MOSH and MOAH contamination from edible vegetable oils.

Crude oils, as extracted from their original source, are not suitable for human consumption due the presence of impurities—such as free fatty acids, phosphatides, metals and pigments—which may be harmful or may cause an undesirable colour, odour or taste. Crude oils are therefore refined before use. The refining process typically consists of three major steps: degumming, bleaching and deodorizing. Optionally, a fourth step of chemical refining is included. An oil obtained after completion of the refining process (called a “refined oil” or more specifically a deodorized oil) is normally considered suitable for human consumption and may therefore be used in the production of any number of foods and beverages.

Unfortunately, existing refining processes are not effective to remove MOSH and/or MOAH. There is a need in the industry to identify an efficient and effective method for reducing MOSH and/or MOAH levels in vegetable oils. The present invention provides such a process.

### SUMMARY OF THE INVENTION

The present invention relates to a process for reducing the content of MOSH and/or MOAH from a vegetable oil selected from the group consisting of palm-based oil, cocoa butter-based oil and any mixtures thereof, and wherein the process is comprising the steps of:
a) Subjecting the vegetable oil to a short-path evaporation, wherein the short-path evaporation is performed at a pressure of below 1 mbar, at an evaporation temperature in a range of from 235 and 290° C., and with a feed rate per unit area of evaporator surface of the shorth-path evaporation equipment in a range of from 35 to 102 kg/h·m², and thus obtaining a retentate vegetable oil and a distillate,
b) Contacting the retentate vegetable oil of step a) with an adsorbent, and obtaining a bleached retentate vegetable oil, and
c) Subjecting the bleached retentate vegetable oil of step b) to a further refining step carried out in an oil refining equipment consisting of a stripping column with packing and not more than one oil collection tray, or in a deodorizer, and obtaining a refined retentate vegetable oil.

### DETAILED DESCRIPTION

The present invention relates to a process for reducing the content of MOSH and/or MOAH from a vegetable oil selected from the group consisting of palm-based oil, cocoa butter-based oil and any mixtures thereof, and wherein the process is comprising the steps of:
a) Subjecting the vegetable oil to a short-path evaporation, wherein the short-path evaporation is performed at a pressure of below 1 mbar, at an evaporation temperature in a range of from 235 and 290° C., and with a feed rate per unit area of evaporator surface of the shorth-path evaporation equipment in a range of from 35 to 102 kg/h·m², and thus obtaining a retentate vegetable oil and a distillate,
b) Contacting the retentate vegetable oil of step a) with an adsorbent, and obtaining a bleached retentate vegetable oil, and
d) Subjecting the bleached retentate vegetable oil of step b) to a further refining step carried out in an oil refining equipment consisting of a stripping column with packing and not more than one oil collection tray, or in a deodorizer, and obtaining a refined retentate vegetable oil.

### Vegetable Oil as Starting Material

The term “palm-based oil” is an oil selected from the group consisting of a palm oil, palm oil stearin, palm oil super stearin, palm oil olein, palm oil super olein, palm oil mid-fraction and blends of one or more thereof.

The term “cocoa butter-based oil” is an oil selected from the group consisting of cocoa butter, cocoa butter olein, cocoa butter stearin and blends of two or more thereof.

Palm-based oil and cocoa butter-based oil are specific examples of vegetable oils with a molecular weight in a range of from 800 to 865 g/mol.

Preferably, the vegetable oil that is subjected to the process of the current invention is palm-based oil.

In one aspect of the invention, the vegetable oil that is subjected to the short-path evaporation of the process is a degummed, bleached and/or deodorized vegetable oil. Preferably the vegetable oil is at least degummed.

Preferably, the vegetable oil is a palm-based oil selected from the group consisting of a palm oil, palm oil stearin, palm oil super stearin, palm oil olein, palm oil super olein, palm oil mid-fraction and blends of one or more thereof, that is degummed, or that is degummed and bleached, or that is degummed, bleached and deodorized.

Crude vegetable oil may be subjected to one or more degumming steps. Any of a variety of degumming processes known in the art may be used. One such process (known as “water degumming”) includes mixing water with the oil and separating the resulting mixture into an oil component and an oil-insoluble hydrated phosphatides component, sometimes referred to as “wet gum” or “wet lecithin”. Alternatively, phosphatide content can be reduced (or further reduced) by other degumming processes, such as acid degumming (using citric or phosphoric acid for instance), enzymatic degumming (e.g., ENZYMAX from Lurgi) or chemical degumming (e.g., SUPERIUNI degumming from Unilever or TOP degumming from VandeMoortele/Dijkstra CS). Alternatively, phosphatide content can also be reduced (or further reduced) by means of acid conditioning, wherein the oil is treated with acid in a high shear mixer and is subsequently sent without any separation of the phosphatides to the bleaching step.

The bleaching step in general is a process step whereby impurities are removed to improve the color and flavor of the oil. It is typically performed prior to deodorization. The nature of the bleaching step will depend, at least in part, on the nature and quality of the oil being bleached. Generally, a crude or partially refined oil will be mixed with a bleaching agent which combines, amongst others, with oxidation products, phosphatides, trace soaps, pigments and other compounds to enable their removal. The nature of the bleaching agent can be selected to match the nature of the crude or partially refined oil to yield a desirable bleached oil. Bleaching agents generally include natural or “activated” bleaching clays, also referred to as “bleaching earths”, activated carbon and various silicates. Natural bleaching agent refers to non-activated bleaching agents. They occur in nature or they occur in nature and have been cleaned, dried, milled and/or packed ready for use. Activated bleaching agent refers to bleaching agents that have been chemically modified, for example by activation with acid or alkali, and/or bleaching agents that have been physically activated, for example by thermal treatment. Activation includes the increase of the surface in order to improve the bleaching efficiency. Further, bleaching clays may be characterized based on their pH value. Typically, acid-activated clays have a pH value of 2.0 to 5.0. Neutral clays have a pH value of 5.5 to 9.0. A skilled person will be able to select a suitable bleaching agent from those that are commercially available based on the oil being refined and the desired end use of that oil.

The bleaching step for obtaining the degummed and bleached vegetable oil that is subjected to the short-path evaporation of the process, is performed at a temperature of from 80 to 115° C., from 85 to 110° C., from 90 to 105° C., in presence of neutral and/or natural bleaching earth in an amount of from 0.2 to 5%, from 0.5 to 3%, or from 0.7 to 1.5% based on amount of oil.

Deodorization is a process whereby free fatty acids (FFAs) and other volatile impurities are removed by treating (or “stripping”) a crude or partially refined oil under vacuum and at elevated temperature with sparge steam, nitrogen or other gasses. The deodorization process and its many variations and manipulations are well known in the art and the deodorization step of the present invention may be based on a single variation or on multiple variations thereof.

For instance, deodorizers may be selected from any of a wide variety of commercially available systems (such as those sold by Krupp of Hamburg, Germany; De Smet Group, S.A. of Brussels, Belgium; Gianazza Technology s.r.l. of Legnano, Italy; Alfa Laval AB of Lund, Sweden Crown Ironworks of the United States, or others). The deodorizer may have several configurations, such as horizontal vessels or vertical tray-type deodorizers.

Deodorization is typically carried out at elevated temperatures and reduced pressure to better volatilize the FFAs and other impurities. The precise temperature and pressure may vary depending on the nature and quality of the oil being processed. The pressure, for instance, will preferably be no greater than 10 mm Hg but certain aspects of the invention may benefit from a pressure below or equal to 5 mm Hg, e.g. 1-4 mm Hg. The temperature in the deodorizer may be varied as desired to optimize the yield and quality of the deodorized oil. At higher temperatures, reactions which may degrade the quality of the oil will proceed more quickly. For example, at higher temperatures, cis-fatty acids may be converted into their less desirable trans form. Operating the deodorizer at lower temperatures may minimize the cis-to-trans conversion, but will generally take longer or require more stripping medium or lower pressure to remove the requisite percentage of volatile impurities. As such, deodorization is typically performed at a temperature of the oil in a range of 200 to 280° C., with temperatures of about 220-270° C. being useful for many oils. For cocoa butter-based oil, a deodorization temperature in a range of 130 to 220° C. is advised. Typically, deodorization is thus occurring in a deodorizer whereby volatile components such as FFAs and other unwanted volatile components that may cause off-flavors in the oil, are removed. Deodorization may also result in the thermal degradation of unwanted components.

The deodorization step for obtaining the degummed, bleached and deodorized vegetable oil that is subjected to the short-path evaporation of the process, is performed at a temperature of from 200° C. to 270° C., from 210° C. to 260° C., or from 220° C. to 250° C. The deodorization step is taking place for a period of time from 30 min to 240 min, from 45 min to 180 min, or from 60 min to 150 min.

The deodorization step for obtaining the degummed, bleached and deodorized vegetable oil that is subjected to the short-path evaporation of the process, is performed in the presence of sparge steam in a range of from 0.50 to 2.50 wt %, from 0.75 to 2.00 wt %, from 1.00 to 1.75 wt %, or from 1.25 to 1.50 wt % based on amount of oil and at an absolute pressure of 10 mbar or less, 7 mbar or less, 5 mbar or less, 3 mbar or less, 2 mbar or less.

Typically, a degummed, bleached and deodorized vegetable edible oil is known to be obtained by means of 2 major types of refining processes, i.e. a chemical or a physical refining process. The chemical refining process may typically comprise the major steps of degumming, alkali refining, also called neutralization, bleaching and deodorizing. The thus obtained deodorized oil is a chemically refined oil, also called “NBD” oil. Alternatively, the physical refining process may typically comprise the major steps of degumming, bleaching and deodorizing. A physically refining process is not comprising an alkali neutralization step as is present in the chemical refining process. The thus obtained deodorized oil is a physically refined oil, also called “RBD” oil.

The palm-based oil that is subjected to the short-path evaporation of the process is a degummed, bleached and deodorized vegetable oil and a method for obtaining the degummed, bleached and deodorized vegetable oil is comprising the steps, of:
i) Degumming and obtaining a degummed palm-based oil,
ii) Optionally alkali neutralizing the degummed palm-based oil from step i),
iii) Bleaching the degummed oil from step i) or the alkali neutralized oil from step ii)
   at a temperature of from 80 to 115° C., from 85 to 110° C., or from 90 105° C., and
   with neutral and/or natural bleaching earth in an amount of from 0.2 to 5%, from 0.5 to 3%, or from 0.7 to 1.5%, and obtaining a degummed and bleached oil, and
iv) Deodorizing the oil from step iii)
   at a temperature of from 200 to 270° C., from 210 to 260° C., or from 220 to 250° C.,
   for a period of time in a range of from 30 min to 240 min, from 45 min to 180 min, or from 60 min to 150 min.

The vegetable oil that is subjected to the short-path evaporation may have a content of MOSH of 20 ppm or higher, 40 ppm or higher, 60 ppm or higher, or even 80 ppm or higher. The content of MOAH may be more than 5 ppm or higher, more than 10 or higher, more than 20 ppm or higher, more than 40 ppm or higher, or even more than 60 ppm or higher.

### Step a) Short-Path Evaporation

Short-path evaporation, also called short-path distillation or molecular distillation, is a distillation technique that involves the distillate travelling a short distance, often only a few centimetres, and it is normally done at reduced pressure. With short path distillation, a decrease of boiling temperature is obtained by reducing the operating pressure. It is a continuous process with very short residence time. This technique is often used for compounds which are unstable at high temperatures or to purify small amounts of compounds. The advantage is that the heating temperature can be considerably lower (at reduced pressure) than the boiling point of the liquid at standard pressure. Additionally, short-path evaporation allows working at very low pressure.

Different types of short-path evaporation apparatus can be used that are well known to the skilled person. Examples are, but are not limited to, falling film, centrifugal, or wiped film evaporation apparatus. Preferably the short-path evaporation of the current process is performed in a wiped film evaporation apparatus.

The short-path evaporation in step a) of the process according to the invention is performed at a pressure below 1 mbar, preferably below 0.05 mbar, more preferably below 0.01 mbar, most preferably below 0.001 mbar.

The short-path evaporation is further performed at specific conditions of evaporation temperature and feed rate per unit area of evaporator surface of the shorth-path evaporation equipment.

The “feed rate per unit area of evaporator surface of the shorth-path evaporation equipment”, also called “specific throughput” or “specific feed rate”, expressed in kg/h·m², is defined as the flow of oil, expressed in kg/h, per unit area of evaporator surface of the short-path evaporation equipment, expressed in m². The feed rate per unit area of evaporator surface of the shorth-path evaporation equipment in the process of the current invention is applicable to any short-path equipment, including industrial short-path evaporation equipment independent of the dimensions of the equipment. Preferably stainless steel short-path evaporation equipment is used in the current invention.

In one aspect of the invention, the short-path evaporation in step a) of the current process is performed at an evaporator temperature in a range of from 235 and 290° C., from 240 to 285° C., or from 245 to 280° C., and with a feed rate per unit area of evaporator surface of the shorth-path evaporation equipment in a range of from 35 to 102 kg/h·m², from 45 to 100 kg/h·m², or from 50 to 95 kg/h·m².

Furthermore, the process of the current invention is not comprising the step of subjecting palm-based oil to a short-path evaporation, wherein the short-path evaporation is performed 0.01 Pa, at a temperature of 250° C., and a feed rate per unit area of evaporator surface of the shorth-path evaporation equipment of 7.2×10⁻³ L/h·cm².

In the process according to the invention, two fractions are obtained from the short-path evaporation in step a): a retentate vegetable oil and a distillate.

The process according to the invention may result in a retentate vegetable oil having a reduced content of MOSH and/or MOAH and a distillate having an elevated content of MOSH and/or MOAH, compared to the vegetable oil that is subjected to the short-path evaporation.

Method DIN EN 16995:2017 (as part of CEN/TC275/WG 13) is the method that is used to measure the content of MOSH as well as the content of MOAH.

The “content of MOSH” is defined as the total amount of saturated hydrocarbons (MOSH) with a carbon chain length in a range of C10 to C50.

The “content of MOAH” is defined as the total amount of aromatic hydrocarbons (MOAH) with a carbon chain length in a range of C10 to C50.

In one aspect of the invention, the short-path evaporation in step a) results in a retentate vegetable oil having a content of MOSH and/or MOAH that is reduced for at least 50%, at least 55%, at least 60%, at least 64%, at least 70%, at least 80%, or even at least 90%, from 50% to 95%, from 55% to 93%, from 60% to 91%, compared to the vegetable oil that is subjected to the short-path evaporation.

The yield of the retentate vegetable oil of the short-path evaporation is more than 80%, more than 85%, more than 90%, or even more than 92%. The yield is expressed as the ratio of the amount of retentate vegetable oil that is obtained versus the amount of vegetable oil that was subjected to the short-path evaporation. The yield is expressed as the ratio of the amount of retentate vegetable liquid oil that is obtained versus the amount of vegetable liquid oil that was subjected to the short-path evaporation.

In a preferred aspect of the invention, the short-path evaporation of the current invention allows obtaining a reduction of MOSH and/or MOAH content of the retentate vegetable palm-based oil may be obtained in a range of from 75 to 95%, while the yield is in a range of from 90 to 97%.

Additionally, the retentate vegetable oil may have a reduced content of glycidyl esters (GE). GE are contaminants that are typically being formed as a result of the oils being exposed to high temperatures during oil processing, especially during deodorization. The GE content of the retentate vegetable oil is below 1.0 ppm, below 0.8 ppm, below 0.5 ppm, below 0.3 ppm, below 0.1 ppm, or below LOQ (limit of quantification). The content of GE is measured with Method DGF Standard Methods Section C (Fats) C-VI 18(10).

Step b) Contacting the Retentate Vegetable Oil with an Adsorbent

In step b) of the process according to the invention, the retentate vegetable oil obtained from step a) is contacted with an adsorbent. A bleached retentate vegetable oil is obtained.

The adsorbent in step b) of the process can be selected from bleaching agent, activated carbon, zeolite, exchange resin, silica and/or two or more combinations thereof. Examples of silica that can be employed in the present process include magnesium silicate, calcium silicate, aluminum silicate and combinations thereof. The activated carbon is preferably acidic activated carbon. The exchange resin is preferably a cation exchange resin. The bleaching agent can be neutral or activated bleaching agent. Activated bleaching agent refers to acid and/or physically activated (e.g. by thermal treatment). Activation includes the increase of the surface in order to improve the bleaching efficiency. Preferably an acid activated bleaching agent is applied.

The amount of adsorbent in step b) of the process is in the range of from 0.3 to 4.0 wt % by weight of oil, in the range from 0.4 to 2.0 wt %, from 0.5 to 1.5 wt %.

The temperature at which the retentate vegetable oil is contacted with the adsorbent in step b) of the process is in the range of from 70 to 120° C., from 80 to 110° C., or from 85 to 100° C.

The contact time with the adsorbent in step b) of the process is in a range of from 15 to 60 minutes, from 20 to 50 minutes, or from 30 to 45 minutes. The retentate vegetable oil is subsequently separated from the adsorbent.

In one aspect of the invention, the retentate vegetable oil obtained from step a) of the process is contacted in step b) with an adsorbent, wherein the adsorbent is an acid-activated bleaching earth that is dosed in an amount of from 0.3 to 4.0 wt % by weight of oil, in the range from 0.4 to 2.0 wt %, from 0.5 to 1.5 wt %, and wherein the adsorbent is contacted with the oil for a period of time of from 15 to 60 minutes, from 20 to 50 minutes, or from 30 to 45 minutes, at a temperature in a range of from 70 to 120° C., from 80 to 110° C., or from 85 to 100° C.

The contacting of the retentate vegetable oil with an adsorbent in step b) of the process, may result, amongst others, in a lowering of the colour of the retentate vegetable oil.

In one aspect of the invention, the bleached retentate palm oil that is obtained from step b) of the process is characterized by a Lovibond red colour of 3.5R or less, 3R or less, or 2.5R or less and/or a Lovibond yellow colour of 35Y or less, 30Y or less, or 25Y or less (measured in a 5¼ inch glass measuring cell according to AOCS method Cc13e-92).

### Step c) Treating the Bleached Retentate Vegetable Oil in a Further Refininm Step

In step c) of the process according to the invention, the bleached retentate vegetable oil is subjected to a further refining carried out in an oil refining equipment consisting of a stripping column with packing and not more than one oil collection tray, or in a deodorizer. A refined retentate vegetable oil is obtained.

The further refining in step c) of the current process is carried out at a temperature below 260° C., below 240° C., or below 220° C.

The further refining in step c) of the current process is carried out in the presence of sparge steam in an amount of from 0.1 to 2.0 wt %, from 0.2 to 1.8 wt %, or from 0.3 to 1.5 wt % based on amount of oil.

The further refining in step c) of the current process is carried out at an absolute pressure of 10 mbar or less, 7 mbar or less, or 5 mbar or less.

In one aspect, the further refining is carried out in an oil refining equipment consisting of a stripping column with packing and not more than one oil collection tray. The refining ability of this refining equipment is obtained from the use of the stripping column and not more than one oil collection tray. It is to be understood that in order to operate the refining equipment, valves, pumps, heat exchangers (heating and/or cooling of the oil), and the like, are needed. An in-line heater may be used before the stripping column

The “not more than one” oil collection tray is a range covering “up to one” collection tray, and thus including also no collection tray.

The “oil refining equipment” is not containing retention trays. Retention trays, retention vessels, or compartments, also known as sections, are always present in standard deodorizer equipment known in the art, whether batch, continuous or semi-continuous deodorizer equipment. In each tray the oil is kept for a certain time at high temperature and steam is introduced into the oil.

It has been found that the height to diameter ratio of the stripping column of the oil refining equipment is from 0.1 to 10, from 0.5 to 5, from 1 to 4.9, from 1.4 to 4.7, from 1.5 to 4.4, from 1.6 to 4.0, or from 1.6 to 3.0

The packing can be random packing or structured packing. Preferably the packing is a structured packing.

The term structured packing is well-known in the technical field and it refers to a range of specially designed materials for use in absorption and distillation columns. Structured packings typically consist of thin corrugated metal plates arranged in a way that force fluids to take complicated paths through the column and thereby creating a large surface, which can enhance the interaction between oil and stripping agent.

The packing in the equipment of the present invention is having a specific surface of from 100 to 750 m²/m³, from 100 to 500 m²/m³, from 150 to 400 m²/m³, from 150 to 300 m²/m³, from 200 to 250 m²/m³.

Furthermore, the stripping column of the oil refining equipment has an oil loading of from 0.5 to 4.0 kg/m² h surface of packing, from 0.6 to 3.5 kg/m² h surface of packing, from 0.8 to 3.3 kg/m² h, from 1.0 to 3.0 kg/m² h, from 1.5 to 2.8 kg/m² h, from 2.0 to 2.5 kg/m² h, preferably from 1.0 to 3.0 kg/m² h.

The “oil refining equipment” allows for a short residence (retention) time. In particular, a total residence time in the refining equipment, including not more than one collection tray, and including a pre-heating (using a heating device prior to passing the oil through the oil refining equipment), is not more than 20 minutes. More in particular, the process of the present invention allows a residence time in the packing of the stripping column of from 1 to 10 minutes

These short residence times are further beneficial to avoid further formation of process contaminants

The stripping agent is steam or any other stripping gas, such as nitrogen gas. Preferably steam is used as stripping agent.

The stripping column is operated at an absolute pressure of below 8 mbar.

The further refining of the bleached retentate vegetable oil in step c) of the process may result in a further improvement of the flavour of the refined retentate vegetable oil. The refined vegetable oil has an overall flavour quality score (taste), according to AOCS method Cg 2-83, in a range of from 7 to 10, or from 8 to 10 or from 9 to 10 (with 10 being an excellent overall flavour quality score and 1 being the worst score).

In one preferred aspect, the further refining in the present process is carried out at a temperature below 220° C., below 210° C., or below 190° C., from 130 to 210° C., or from 150 to 185° C. This further refining at a temperature below 220° C. may result in a retentate vegetable oil that is reduced in MOSH and/or MOAH, and that has a reduced content of GE, and that has a taste that is acceptable to good. The GE content of the retentate vegetable oil is below 1 ppm, below 0.8 ppm, below 0.5 ppm, below 0.3 ppm, below 0.1 ppm, or below LOQ (limit of quantification). The thus obtained refined vegetable oil has also an overall flavour quality score (taste), according to AOCS method Cg 2-83, in a range of from 7 to 10, or from 8 to 10 or from 9 to 10 (with 10 being an excellent overall flavour quality score and 1 being the worst score).

### Examples

### 1. Starting Material

Refined, bleached and deodorized (RBD) palm oil stearin was spiked with 75 ppm of a master-mix based on lubricants, lube sprays and used engine oil containing MOSH-MOAH. Table 1 describes the composition of the MOSH-MOAH master-mix.

TABLE 1
MOSH-MOAH master-mix

| Lubricants & used engine oil | Part |
|---|---|
| Cassida Fluid HF 46 | 1 |
| Cassida Fluid HF 15 | 1 |
| Rivolta TRS Plus Spray | 1 |
| Rivolta SKS 48 | 1 |
| Panreco Drageol | 1 |
| Used engine oil - 15W40 | 3 |

### 2. SPE Conditions

Short-Path Evaporation (SPE) Unit KD10 from UIC was used for the short-path evaporation. The KD10 unit has an evaporator surface of 0.1 m²

The following conditions were applied:
Feed-temperature: 144° C.
Condenser Temp.: 140° C.
Wiper speed: 400 rpm
Pressure: below 10⁻³ mbar
Test conditions: Feed rate per unit area of evaporator surface of the shorth-path evaporation equipment (in kg/h·m²) and evaporation temperature were set as given in table 2.

TABLE 2
Test conditions and spiking levels

| Test | Evaporation | Feed rate per unit area of evaporator |
|---|---|---|
| number | temperature | surface of in KD10 (kg/h · m²) |
| Test 1 | 250° C. | 49 |
| Test 2 | 280° C. | 102 |

Thus, the example is conducted according to the specifications of the claims.

### 3. Results

MOSH and MOAH content of the oils was analyzed for the spiked RBD oils before the SPE treatment (=starting material of test) and after (=retentate of test). The yield of the retentate vegetable oil was calculated based on the amount of retentate vegetable oil after SPE treatment versus the amount of spiked RBD oil before the SPE treatment. The results are shown in Table 3.

TABLE 3
Results

| | | | | MOSH + | |
|---|---|---|---|---|---|
| | | | | MOAH | |
| | MOSH | | MOAH | C10-C50 | Retentate |
| | C10-C50 | | C10-C50 | reduction | yield |
| Starting material | 87.0 | ppm | 2.2 ppm | | |
| (RBD palm stearin | | | | | |
| oil) | | | | | |
| Test 1 | 19.0 | ppm | 0.0 ppm | 78.7% | 96.5% |
| Test 2 | 6.6 | ppm | 0.0 ppm | 92.6% | 90.4% |

### 4. Bleaching and Further Refining

The retentate of test 2 (retentate palm oil) is contacted during 30 min with 0.2% (w/w) of acid-activated bleaching clay (Taiko Classic) at a pressure of 200 mbar and at a temperature of 100° C.

The bleached retentate palm oil is further refined using a stripping column with a structured packing with 9.12 m² area at an oil loading of 2.4 kg/m² h surface of packing at a pressure of 5.3 mbar and temperature of 180° C. Sparge steam 0.3% (w/w) is contacted in counter-current with the oil that is running top-down over the structured packing. The oil retention time in the stripping column is 3.3 minutes. Refined retentate palm oil is obtained.

GE content, color and taste are analyzed.

1. A process for reducing the content of MOSH and/or MOAH from a vegetable oil selected from the group consisting of palm-based oil, cocoa butter-based oil and any mixtures thereof, wherein the process comprises:
a) Subjecting the vegetable oil to a short-path evaporation to obtain a retentate vegetable oil and a distillate, wherein the short-path evaporation is performed at a pressure of below 1 mbar, at an evaporation temperature in a range of from 235 and 290° C., and with a feed rate per unit area of evaporator surface of the shorth-path evaporation equipment in a range of from 35 to 102 kg/h·m²,
b) Contacting the retentate vegetable oil of step a) with an adsorbent, and obtaining a bleached retentate vegetable oil, and
c) Subjecting the bleached retentate vegetable oil of step b) to a further refining step carried out in an oil refining equipment consisting of a stripping column with packing and not more than one oil collection tray, or in a deodorizer, and obtaining a refined retentate vegetable oil.

2. The process according to claim 1, wherein the short-path evaporation in step a) is performed at a pressure below 0.01 mbar.

3. The process according to claim 1, wherein the vegetable oil in step a) is degummed, bleached and/or deodorized.

4. The process according to claim 1, wherein the vegetable oil in step a) is at least degummed.

5. The process according to claim 1, wherein the vegetable oil in step a) is a palm oil, palm oil stearin, palm oil super stearin, palm oil olein, palm oil super olein, palm oil mid-fraction or blends of one or more thereof.

6. The process according to claim 1, wherein the adsorbent in step b) is an acid-activated bleaching earth that is dosed in an amount of from 0.3 to 4.0 wt % by weight of the retentate vegetable oil, and wherein the adsorbent is contacted with the oil for a period of time [[of]] from 15 to 60 minutes and at a temperature of range of from 70 to 120° C.

7. The process according to claim 1, wherein the further refining in step c) is carried out at a temperature below 260° C.

8. The process according to claim 1, wherein the further refining in step c) is carried out at a temperature below 220° C.

9. The process according to claim 1, wherein the further refining step c) is carried out in the presence of sparge steam in a range of from 0.1 to 2.0 wt % based on amount of the bleached retentate vegetable oil.

10. The process according to claim 1, wherein the further refining in step c) is carried out in an oil refining equipment consisting of a stripping column with packing and not more than one oil collection tray, the packing having a specific surface of from 100 to 750 m²/m³.

11. The process according to claim 10, wherein the stripping column has an oil loading of from 0.5 to 4.0 kg/m² h surface of packing.
